(19) United States
(12) Patent Application Publication
(10) Pub. No.: US 2026/0214674 A1
(43) Pub. Date: Jul. 23, 2026

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingtoke (GB); Shin Horng WONG, Basingtoke (GB)

(73) Assignee: Sony Group Corporation, Tokyo (JP)

(21) Appl. No.: 19/137,296

(22) PCT Filed: Jan. 10, 2024
(86) PCT No.: PCT/EP2024/050493

§ 371 Date: Jun. 10, 2025

(30) Foreign Application Priority Data
Jan. 17, 2023 (EP) 23152100.6

(51) Int. Cl. H04W 72/21; H04W 72/0446; H04W 72/0453

(52) U.S. Cl. CPC H04W 72/21; H04W 72/0446; H04W 72/0453

(57) ABSTRACT

A method of operating a communications device is provided. The method comprises determining that the communications device is to transmit an uplink transmission to a wireless communications network at least partially within a first set of resources of a wireless radio interface, the first set of resources being within a first frequency range, determining that a portion of the uplink transmission at least partially overlaps in time and frequency with one or more resource units configured for the transmission of downlink transmissions within the first frequency range, performing a re-mapping procedure on at least the portion of the uplink transmission, and transmitting, after performing the re-mapping procedure, the uplink transmission to the wireless communications network.

### BACKGROUND

### Field of Disclosure

The present disclosure relates to communications devices, infrastructure equipment and methods for the more efficient and effective operation of communications devices and infrastructure equipment in a wireless communications network.

The present application claims the Paris Convention priority from European patent application number EP23152100.6, filed on 17 Jan. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Some embodiments of the present technique can provide a first method of operating a communications device. The method comprises determining that the communications device is to transmit an uplink transmission to a wireless communications network at least partially within a first set of resources of a wireless radio interface, the first set of resources being within a first frequency range, determining that a portion of the uplink transmission at least partially overlaps in time and frequency with one or more resource units configured for the transmission of downlink transmissions within the first frequency range, performing a re-mapping procedure on at least the portion of the uplink transmission, and transmitting, after performing the re-mapping procedure, the uplink transmission to the wireless communications network.

Some other embodiments of the present technique can provide a second method of operating a communications device. The method comprises determining that the communications device is to receive a downlink transmission from a wireless communications network at least partially within a first set of resources of a wireless radio interface, the first set of resources being within a first frequency range, determining that a portion of the downlink transmission at least partially overlaps in time and frequency with one or more resource units configured for the transmission of uplink transmissions within the first frequency range, determining that the wireless communications network is to perform a re-mapping procedure on at least the portion of the downlink transmission, and receiving, in accordance with the determined re-mapping procedure, the downlink transmission from the wireless communications network. Such embodiments of the present technique, which, in addition to methods of operating communications devices, relate to methods of operating infrastructure equipment, communications devices and infrastructure equipment, circuitry for communications devices and infrastructure equipment, computer programs, and computer-readable storage mediums, can allow for the more efficient and effective use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference;

FIG. 5 illustrates an example approach for accounting for inter-cell cross link interference;

FIG. 6 schematically illustrates an example of intra-cell cross link interference;

FIG. 7 illustrates a first example division of system bandwidth into dedicated non-overlapping uplink and downlink sub-bands;

FIG. 8 illustrates a second example division of system bandwidth into dedicated non-overlapping uplink and downlink sub-bands extending across multiple slots;

FIG. 9 illustrates a third example division of system bandwidth into dedicated non-overlapping uplink and downlink sub-bands within a single slot;

FIG. 10 shows how uplink transmissions may overlap with downlink sub-bands due to such uplink transmissions crossing a boundary between SBFD symbols and non-SBFD symbols;

FIG. 11 shows a part schematic, part message flow diagram representation of a first wireless communications system comprising a communications device and an infrastructure equipment in accordance with embodiments of the present technique;

FIG. 12 shows a part schematic, part message flow diagram representation of a second wireless communications system comprising a communications device and an infrastructure equipment in accordance with embodiments of the present technique;

FIG. 13 illustrates a first example of a re-mapping procedure for an uplink transmission which collides with a downlink sub-band in accordance with embodiments of the present technique;

FIG. 14 illustrates a first example of a re-mapping procedure for a downlink transmission which collides with an uplink sub-band, in which the entire downlink transmission is re-mapped, in accordance with embodiments of the present technique;

FIG. 15 illustrates a second example of a re-mapping procedure for a downlink transmission which collides with an uplink sub-band, in which only the colliding portion of the downlink transmission is re-mapped, in accordance with embodiments of the present technique;

FIG. 16 illustrates a third example of a re-mapping procedure for a downlink transmission which collides with an uplink sub-band, in which the colliding portion of the downlink transmission is dropped, in accordance with embodiments of the present technique in accordance with embodiments of the present technique;

FIG. 17 illustrates a second example of a re-mapping procedure for an uplink transmission which collides with a downlink sub-band, in which the colliding portion of the uplink transmission is re-mapped to a preconfigured supplementary uplink resource, in accordance with embodiments of the present technique;

FIG. 18 illustrates a fourth example of a re-mapping procedure for a downlink transmission which collides with an uplink sub-band, in which the entire downlink transmission is reflected across a reflection point, in accordance with embodiments of the present technique;

FIG. 19 shows a flow diagram illustrating a first process of communications in a communications system in accordance with embodiments of the present technique; and

FIG. 20 shows a flow diagram illustrating a second process of communications in a communications system in accordance with embodiments of the present technique.

### DETAILED DESCRIPTION OF THE EMBODIMENTS

### Long Term Evolution Advanced Radio Access Technology (4G)

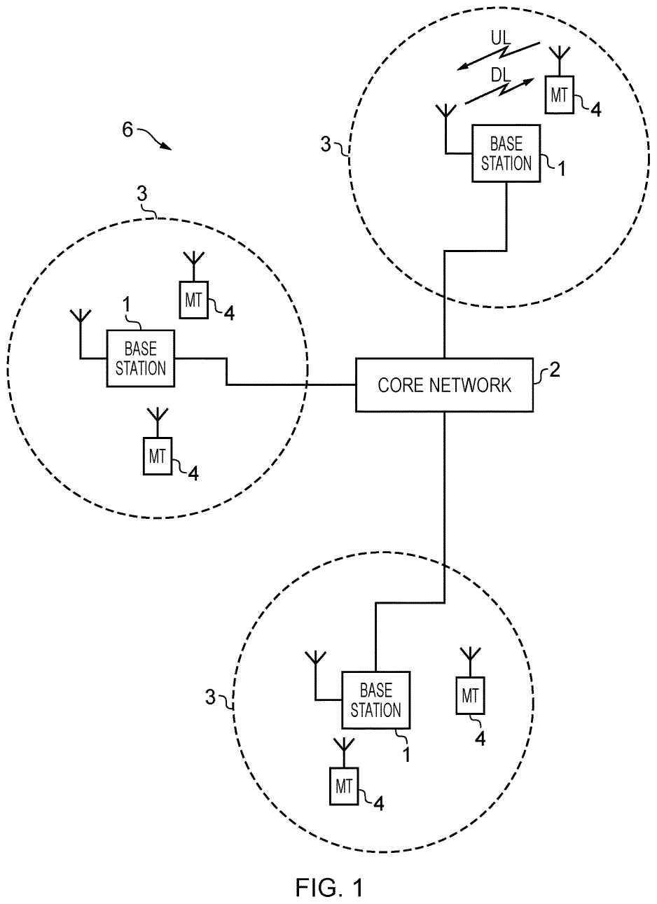

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10-5 (99.999 %) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

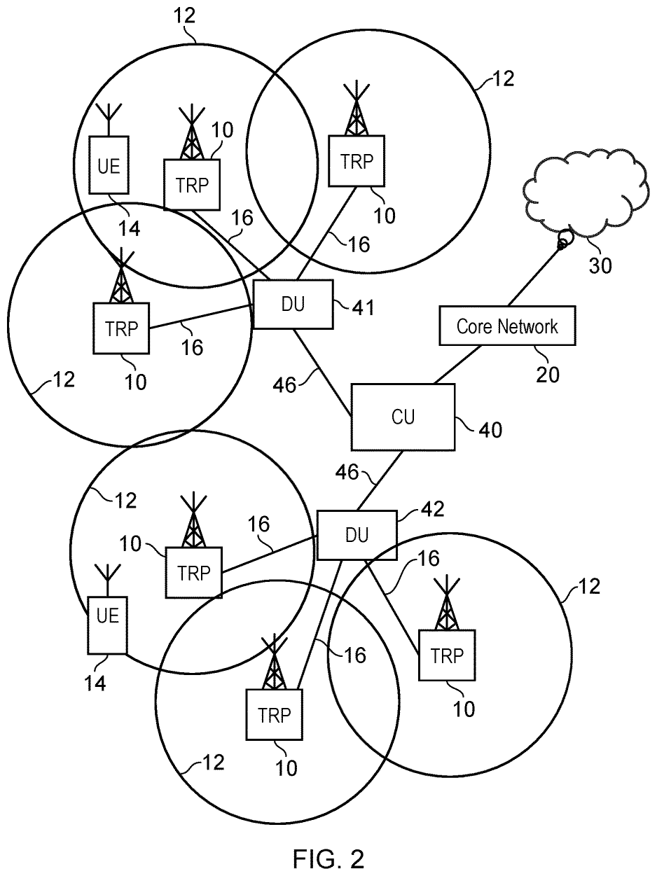

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

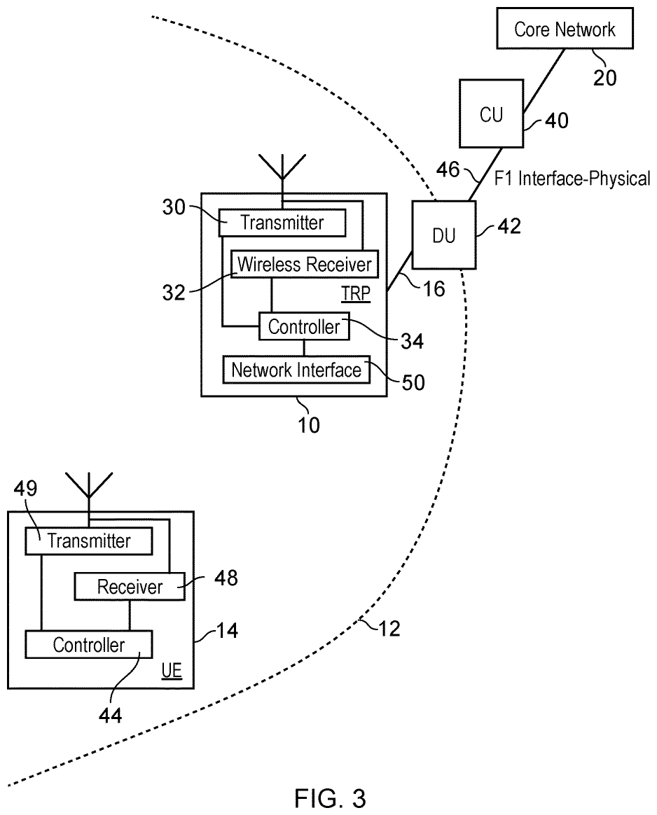

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Multiplexing (TDD) by enabling Full Duplex operation in TDD (FD-TDD) [3], [4].

Motivations for enhancing duplexing operation for TDD include an improvement in system capacity, reduced latency, and improved uplink coverage. For example, in current HD-TDD systems, OFDM symbols are allocated only for either a DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

In FD-TDD, a gNB can transmit and receive data to and from the UEs at the same time on the same frequency band. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling an UL transmission from a second UE within the same orthogonal frequency division multiplexing (OFDM) symbol (i.e. at the same time).

Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode. This allows legacy TDD UEs that are Half Duplex to benefit from the FD-TDD operation, which reduces complexity at the UE and enables faster introduction of FD-TDD into the market.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL), Uplink (UL) or Flexible (F). An OFDM symbol that is semi-statically configured to be Flexible can be indicated dynamically as DL, UL or remain as Flexible by a Dynamic Slot Format Indicator (SFI), which is transmitted in a Group Common (GC) DCI using DCI Format 2_0, where the CRC of the GC-DCI is masked with SFI-RNTI. Flexible OFDM Symbols that remain Flexible after instruction from the SFI can be changed to a DL symbol or an UL symbol by a DL Grant or a UL Grant respectively. That is, a DL Grant scheduling a PDSCH that overlaps Flexible OFDM Symbols would convert these Flexible OFDM Symbols to DL and similarly an UL Grant scheduling a PUSCH that overlaps Flexible OFDM Symbols would convert these Flexible OFDM Symbols to UL.

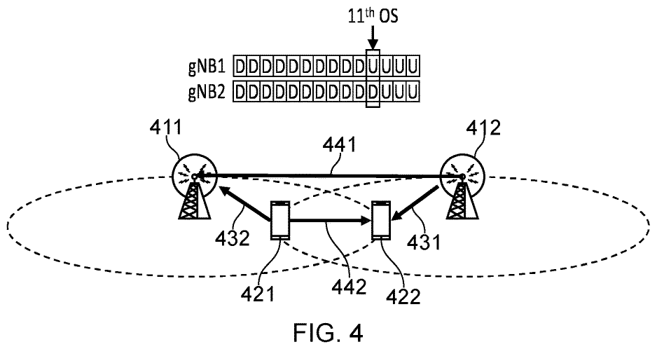

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs (due to the UL/DL symbol clash for one or more symbols). Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 411 and gNB2 412 have synchronised slots. At a given slot, gNB1's 411 slot format={D, D, D, D, D, D, D, D, D, D, U, U, U, U} whilst gNB2's 412 slot format={D, D, D, D, D, D, D, D, D, D, D, U, U, U}, where ‘D’ indicates DL and ‘U’ indicates UL. Inter-cell CLI occurs during the 11^{th} OFDM symbol of the slot, where gNB1 411 is performing UL whilst gNB2 412 is performing DL. Specifically, inter-cell CLI 441 occurs between gNB1 411 and gNB2 412, where gNB2's 412 DL transmission 431 interferes with gNB1's 411 UL reception 432. CLI 442 also occurs between UE1 421 and UE2 422, where UE1's 421 UL transmission 432 interferes with UE2's 422 DL reception 431.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). In SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

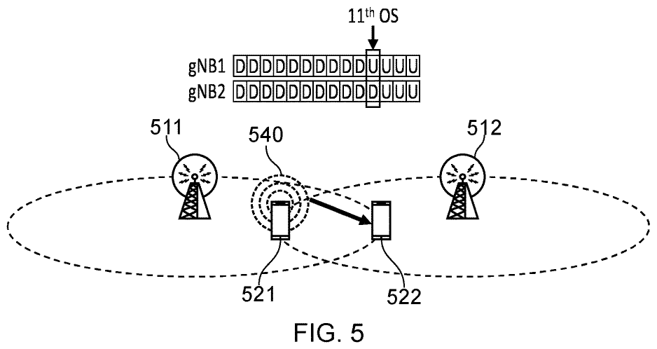

Both SRS-RSRP and CLI-RSSI are RRC measurements and are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11^{th} OS (OFDM symbol) of gNB1 511 and gNB2 512 causes inter-cell CLI. Here, gNB1 511 has configured UE1 521, the aggressor UE, to transmit an SRS 540 and gNB2 512 has configured UE2 522, the victim UE, to measure that SRS 540. UE2 522 is provided with UE1's 521 SRS configured parameters, e.g. RS sequence used, frequency resource, frequency transmission comb structure and time resources, so that UE2 522 can measure the SRS 540. In general, a UE can be configured to monitor 32 different SRSs, at a maximum rate of 8 SRSs per slot.

For CLI-RSSI measurements, the UE measures the total received power, i.e. signal and interference, following a configured periodicity, start and end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast, CLI-RSSI cannot be used to identify a specific aggressor UE's transmission, but CLI-RSSI does provide an overall estimate of the inter-cell CLI experienced by the victim UE.

### Intra-Cell Cross Link Interference (CLI) and Sub-band Full Duplex (SBFD)

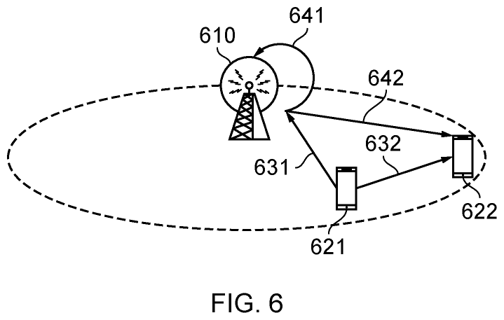

In addition to inter-cell CLI and remote interference, FD-TDD also suffers from intra-cell CLI at the gNB and at the UE. An example is shown in FIG. 6, where a gNB 610 is capable of FD-TDD and is simultaneously receiving UL transmission 631 from UE1 621 and transmitting a DL transmission 642 to UE2 622. At the gNB 610, intra-cell CLI is caused by the DL transmission 642 at the gNB's transmitter self-interfering 641 with its own receiver that is trying to decode UL signals 631. At UE 2 622, intra-cell CLI 632 is caused by an aggressor UE, e.g. UE1 621, transmitting in the UL 631, whilst a victim UE, e.g. UE2 622, is receiving a DL signal 642.

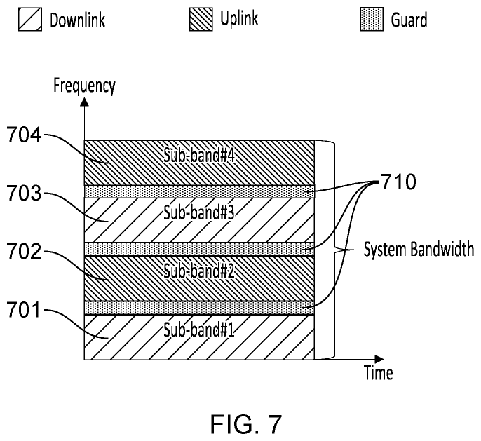

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility being considered in [3], [4] is Sub-band Full Duplex (SBFD). In SBFD, the frequency resource of a TDD system bandwidth or Bandwidth Part (BWP) (i.e. at the UE/gNB) is divided into two or more non-overlapping sub-bands, where each sub-band can be DL or UL [5]. An example is shown in FIG. 7, where simultaneous DL and UL transmissions occur in different non-overlapping sub-bands 701 to 704, i.e. in different sets of frequency Resource Blocks (RB): Sub-band #1 701, Sub-band #2 702, Sub-band #3 703 and Sub-band #4 704 such that Sub-band #1 701 and Sub-band #3 703 are used for DL transmissions whilst Sub-band #2 702 and Sub-band #4 704 are used for UL transmissions.

While FIG. 7 shows the system bandwidth as being divided into four sub-bands, substantially any number of sub-bands could be used. For example, the system bandwidth may be divided into three sub-bands, which may include two downlink sub-bands 701, 703 and one uplink sub-band 702, though other sub-band arrangements are envisioned. To reduce leakage from one sub-band 701 to 704 to another, a guard sub-band 710 may be configured between UL and DL sub-bands 701 to 704. Guard sub-bands 710 are configured between UL Sub-band #4 704 and DL Sub-band #3 703, between DL Sub-band #3 703 and UL Sub-band #2 702 and between UL Sub-band #2 702 and DL Sub-band #1 701. The arrangement of sub-bands 701 to 704 shown in FIG. 7 is just one possible arrangement of the sub-bands and other arrangements are possible, and guard bands may be used in substantially any sub-band arrangement.

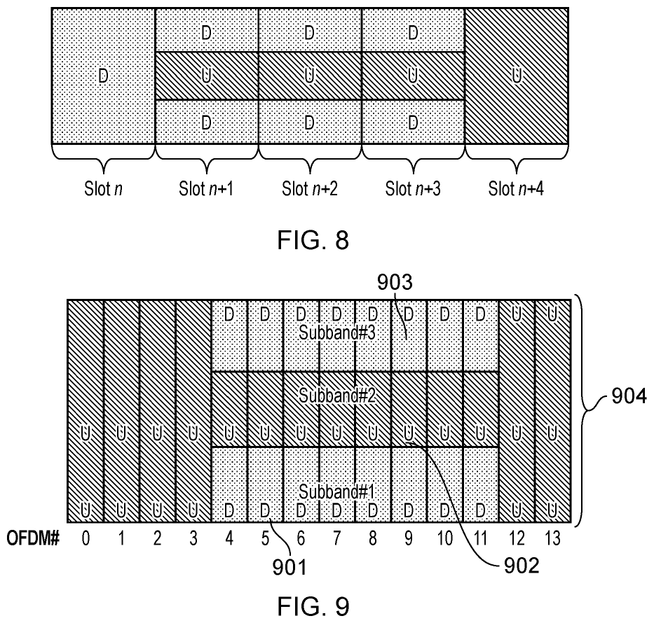

SBFD may not be configured for all slots. That is, some slots can be fully DL slots (D) or fully UL slots (U), whilst others may be SBFD slots. This is illustrated in an example in FIG. 8, which shows five slots (labelled as Slots n, n+1, n+2, n+3 and n+4) where Slot n and Slot n+4 are fully DL and UL respectively. Slots n+1, n+2 and n+3 on the other hand are SBFD slots, consisting of two DL sub-bands and one UL sub-band in the middle. SBFD may also be configured to occupy a subset of OFDM symbols within a single slot. An example in shown in FIG. 9, where a slot is configured with SBFD consisting of two DL sub-bands (i.e., Sub-band #1 901 and Sub-band #3 903) and one UL sub-band (i.e., Sub-band #2 902) in OFDM symbols 4 to 11 of the slot, whilst OFDM symbols 0, 1, 2, 3, 12 and 13 are fully uplink.

That is to say, the uplink resources (UL RBs) available change depending on, for particular symbols, whether SBFD is configured or not. It is also possible that even between SBFD slots, the UL sub-band may have different sizes. This changing of UL resources can be generalised by viewing the slot structure as having multiple UL sub-bands of different sizes. For example, in FIG. 9, it can be generalised that there are two UL sub-bands, Sub-band #2 902 and Sub-band #4 904, where Sub-band #4 904—which occurs between OFDM symbols 0 to 3 and 12 and 13—is a special case, where the entire BWP consists of only UL resources.

With regard to the above discussion relating to FIGS. 8 and 9, it can be seen that-where resources may alternative between DL and UL between slots or symbols for certain frequencies-it is possible that, for example, an UL transmission which begins in UL resources in a particular frequency band or region may extend in time within the same frequency band or region into one or more symbols or slots where the resources configured at such a frequency band or region are DL resources. In order to handle potential collisions between UL transmissions and DL sub-bands, or indeed DL transmissions and UL sub-bands, a well-defined procedure is needed for UEs which support SBFD. In other words, procedures are required in respect of how to handle UL transmissions that cross boundaries between SBFD and non-SBFD symbols or slots.

Of course, a gNB would not deliberately schedule UL or DL transmissions in such a way that these would collide with DL or UL sub-bands. However, there are several reasons that may cause this to happen. For example, such UL transmissions or DL transmissions may be repetitions of PUSCH or PDSCH that extend across SBFD symbols or slots and non-SBFD symbols or slots, or may be periodic transmissions, where the initially allocated resources for such transmissions were valid and not causing collisions, but the repetitions or later instances of the periodic transmission did collide with sub-bands configured for transmissions in the opposite direction. The resources may, for example, be semi-persistent resources or configured grant resources within which UEs are able to schedule their own transmissions in the uplink and periodically monitor for potential downlink transmissions. Here, a UE might schedule itself an UL transmission in resources it considers to be UL, but since these resources may be dynamically or semi-statically changed by the gNB, the UE's understanding of the resource configuration may be out of date, or the resources may have been dynamically or semi-statically changed by the time the UE transmits later repetitions or periodic instances of the initially scheduled UL transmission. Those skilled in the art would of course appreciate that such examples are not exhaustive, and that there are many reasons that may cause an UL transmission to collide with a DL sub-band in such a way, or indeed a DL transmission to collide with an UL sub-band.

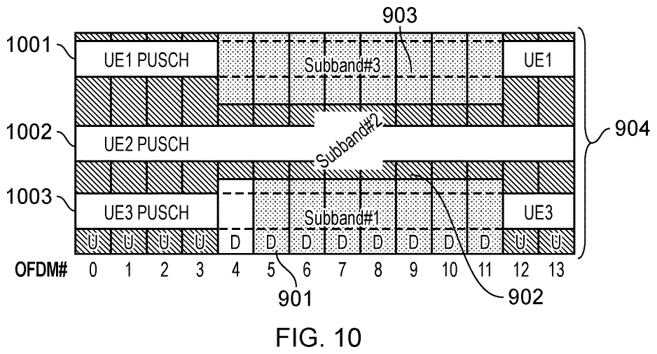

An example of such a potential collision is shown in FIG. 10, where—in the same manner as the example of FIG. 9—a slot is configured with SBFD consisting of two DL sub-bands (i.e., Sub-band #1 901 and Sub-band #3 903) and one UL sub-band (i.e. Sub-band #2 902) in OFDM symbols 4 to 11 of the slot, whilst OFDM symbols 0, 1, 2, 3, 12 and 13 are fully uplink. Here, while a PUSCH transmission 1002 for UE2 extends across the slot whilst remaining within UL sub-bands (i.e., Sub-band #4 904 and Sub-band #2 902), a PUSCH transmission 1001 for UE1 overlaps with DL Sub-band #3 903 in OFDM symbols 4 to 11 in the slot. Similarly, PUSCH transmission 1003 for UE3 overlaps with DL Sub-band #1 901 in OFDM symbols 4 to 11 in the slot. Clearly, this presents an issue, as it would not be possible for UEs 1 and 3 to maintain transmission of PUSCH transmissions 1001 and 1003 respectively during OFDM symbols 4 to 11 of the slot.

Therefore, a technical issue to solve is how to handle UL transmissions that cross SBFD and non-SBFD symbols/slots. In addition, another technical issue to solve is whether an UL transmission which overlaps with one or more DL sub-bands can be remapped to another location/resource within the same slot. Here, the UL transmission may consist of single transmission in a slot or may include a plurality of repetition transmissions over multiple slots. Similarly, and as mentioned above, DL transmissions may also cross the boundaries between SBFD and non-SBFD symbols/slots, where part or all of a DL transmission may overlap with one or more UL sub-bands, or some repetitions of a DL transmissions may overlap with one or more UL sub-bands whilst other repetitions do not. Embodiments of the present technique therefore seek to provide solutions to address such issues and propose new methods which are effective and suitable for UEs which support SBFD operations.

### DL/UL Transmissions Across SBFD and Non-SBFD Symbols/Slots

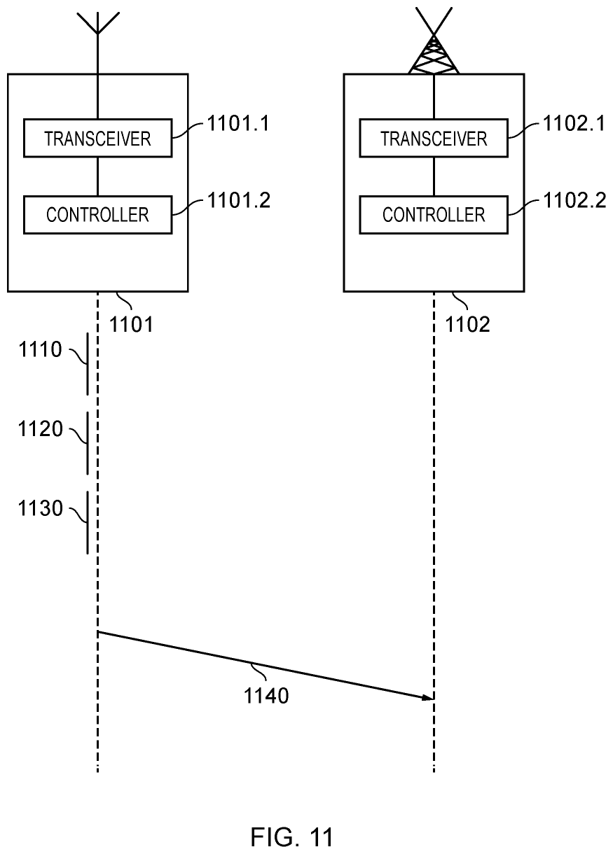

FIG. 11 shows a part schematic, part message flow diagram representation of a first wireless communications system comprising a communications device 1101 and an infrastructure equipment 1102 in accordance with at least some embodiments of the present technique. The communications device 1101 is configured to transmit signals to and/or receive signals from the wireless communications network, for example, to and from the infrastructure equipment 1102. Specifically, the communications device 1101 may be configured to transmit data to and/or receive data from the wireless communications network (e.g., to/from the infrastructure equipment 1102) via a wireless radio interface provided by the wireless communications network (e.g., a Uu interface between the communications device 1101 and the Radio Access Network (RAN), which includes the infrastructure equipment 1102). The communications device 1101 and the infrastructure equipment 1102 each comprise a transceiver (or transceiver circuitry) 1101.1, 1102.1, and a controller (or controller circuitry) 1101.2, 1102.2. Each of the controllers 1101.2, 1102.2 may be, for example, a microprocessor, a CPU, or a dedicated chipset, etc.

As shown in the example of FIG. 11, the transceiver circuitry 1101.1 and the controller circuitry 1101.2 of the communications device 1101 are configured in combination to determine 1110 that the communications device 1101 is to transmit an uplink transmission to a wireless communications network (e.g. to the infrastructure equipment 1102) at least partially within a first set of resources of a wireless radio interface, the first set of resources being within a first frequency range, to determine 1120 that a portion of the uplink transmission at least partially overlaps in time and frequency with one or more resource units configured for the transmission of downlink transmissions within the first frequency range, to perform 1130 a re-mapping procedure on at least the portion of the uplink transmission, and to transmit 1140, after performing the re-mapping procedure 1130, the uplink transmission to the wireless communications network (e.g. to the infrastructure equipment 1102).

Here, those skilled in the art would appreciate that the one or more resource units configured for the transmission of downlink transmissions within the first frequency range with which the portion of the uplink transmission at least partially overlaps in time and frequency (as determined 1120 by the communications device 1101 in the example of FIG. 11) may be SBFD resources. In other words, the one or more resource units configured for the transmission of downlink transmissions within the first frequency range form a downlink sub-band within a specified time period, wherein the downlink sub-band is adjacent to one or more uplink sub-bands within the specified time period (and indeed one or more other downlink sub-bands may also be present within the system bandwidth, with the SBFD configuration here not being limited to any specific configurations). For example, the SBFD configuration may look similar to that shown in FIG. 7, where the portion of the uplink transmission at least partially overlaps in time and frequency with a downlink sub-band such as sub-band #3 703 as shown in FIG. 7, or the SBFD configuration may look similar to that shown in FIG. 10, where the portion of the uplink transmission (e.g., a transmission such as PUSCH 1002) at least partially overlaps in time and frequency with a downlink sub-band such as subband #2 902 as shown in FIG. 10.

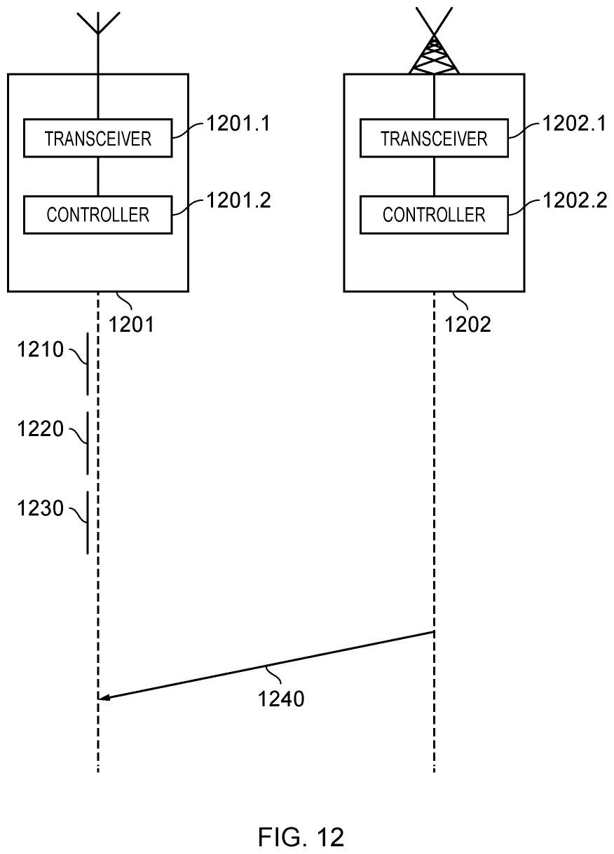

FIG. 12 shows a part schematic, part message flow diagram representation of a second wireless communications system comprising a communications device 1201 and an infrastructure equipment 1202 in accordance with at least some embodiments of the present technique. The communications device 1201 is configured to transmit signals to and/or receive signals from the wireless communications network, for example, to and from the infrastructure equipment 1202. Specifically, the communications device 1201 may be configured to transmit data to and/or receive data from the wireless communications network (e.g., to/from the infrastructure equipment 1202) via a wireless radio interface provided by the wireless communications network (e.g., a Uu interface between the communications device 1201 and the Radio Access Network (RAN), which includes the infrastructure equipment 1202). The communications device 1201 and the infrastructure equipment 1202 each comprise a transceiver (or transceiver circuitry) 1201.1, 1202.1, and a controller (or controller circuitry) 1201.2, 1202.2. Each of the controllers 1201.2, 1202.2 may be, for example, a microprocessor, a CPU, or a dedicated chipset, etc.

As shown in the example of FIG. 12, the transceiver circuitry 1201.1 and the controller circuitry 1201.2 of the communications device 1201 are configured in combination to determine that the communications device is to receive 1210 a downlink transmission from a wireless communications network (e.g., from the infrastructure equipment 1202) at least partially within a first set of resources of a wireless radio interface, the first set of resources being within a first frequency range, to determine 1220 that a portion of the downlink transmission at least partially overlaps in time and frequency with one or more resource units configured for the transmission of uplink transmissions within the first frequency range, to determine 1230 that the wireless communications network (e.g. the infrastructure equipment 1202) is to perform a re-mapping procedure on at least the portion of the downlink transmission, and to receive 1240, in accordance with the determined re-mapping procedure, the downlink transmission from the wireless communications network (e.g., from the infrastructure equipment 1202).

Here, similarly to FIG. 11 as described above, those skilled in the art would appreciate that the one or more resource units configured for the transmission of uplink transmissions within the first frequency range with which the portion of the downlink transmission at least partially overlaps in time and frequency (as determined 1220 by the communications device 1201 in the example of FIG. 12) may be SBFD resources. In other words, the one or more resource units configured for the transmission of uplink transmissions within the first frequency range form an uplink sub-band within a specified time period, wherein the uplink sub-band is adjacent to one or more downlink sub-bands within the specified time period (and indeed one or more other uplink sub-bands may also be present within the system bandwidth, with the SBFD configuration here not being limited to any specific configurations). For example, the SBFD configuration may look similar to that shown in FIG. 7, where the portion of the downlink transmission at least partially overlaps in time and frequency with an uplink sub-band such as sub-band #2 702 as shown in FIG. 7.

Here, those skilled in the art would appreciate that the portion of the uplink/downlink transmission (i.e., that which overlaps/collides with resources configured for transmissions in the opposite direction) referred to in the paragraphs above and elsewhere herein are not necessarily the initial transmission but may instead be a repetition or part of a repetition of that initial transmission. Alternatively, such a transmission (if in the uplink) may be for example an uplink transmission performed by the communications device using pre-configured periodic uplink resources (e.g., a CG-PUSCH) or, if the transmission is in the downlink, it may be for example a downlink reception monitored for by the communications device on pre-configured periodic downlink resource (e.g. SPS). Therein, the “first set of resources” as described above in the examples of FIGS. 11 and 12 may be, for example, configured grant resources, or a first set of allocated resources with either a pre-set or dynamically configured number of repetitions to follow, where one (or more) of the repetitions is the portion which collides with the sub-band in the opposite direction. As mentioned above, it is unlikely that a gNB would allocate a transmission which it knows will cause a collision with resources in the opposite direction, but there are nevertheless a number of reasons why such a collision may be cause. The examples as to why this may happen as described in this paragraph and elsewhere herein are not intended to be limiting.

Essentially, embodiments of the present technique propose that, when there is a transmission which extends across both SBFD and non-SBFD symbols or slots (or indeed any other feasible time resource, such as sub-slots), the UE performs remapping of the transmission to another frequency resource in a sub-band (which may be either SBFD or non-SBFD) of the same slot or other time resource.

In some arrangements of embodiments of the present technique, if a portion of a DL/UL transmission collides with an UL/DL sub-band, that portion that experiences collision is remapped. In other words, the re-mapping procedure may comprise shifting only the portion of the uplink or downlink transmission to a second set of resources of the wireless radio interface, the second set of resources being within a second frequency range different (in frequency but not time) to the first frequency range.

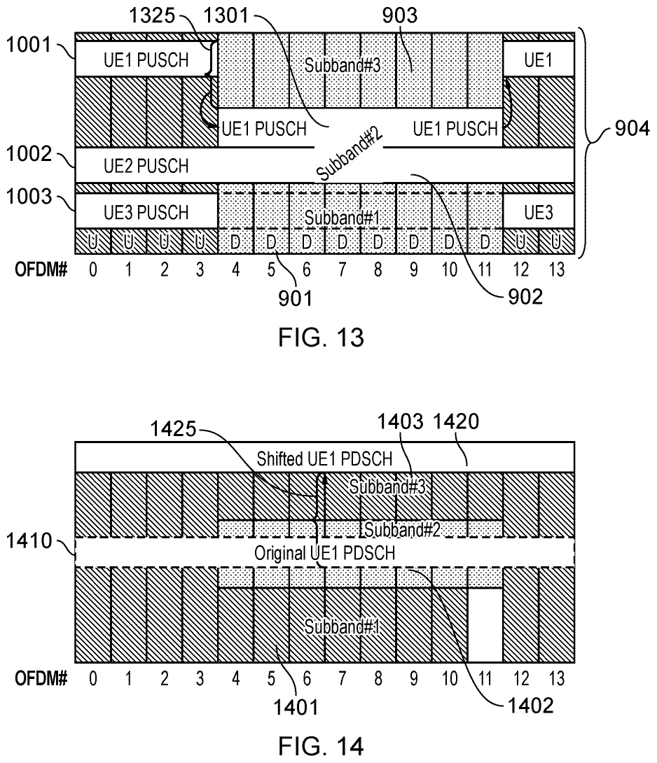

For example, if an UL transmission for a UE collides with a DL sub-band, and if there is an UL SBFD sub-band available on the same BWP, the gNB/network can indicate that the UL transmission is to be remapped to a different frequency resource. An example of such arrangements is shown in FIG. 13, where-in the same manner as the example of FIG. 10—a slot is configured with SBFD consisting of two DL sub-bands (i.e., Sub-band #1 901 and Sub-band #3 903) and one UL sub-band (i.e., Sub-band #2 902) in OFDM symbols 4 to 11 of the slot, whilst OFDM symbols 0, 1, 2, 3, 12 and 13 are fully uplink.

Here, while a PUSCH transmission 1002 for UE2 extends across the slot whilst remaining within UL sub-bands (i.e., Sub-band #4 904 and Sub-band #2 902), a PUSCH transmission 1001 for UE1 overlaps with DL Sub-band #3 903 in OFDM symbols 4 to 11 in the slot. Similarly, PUSCH transmission 1003 for UE3 overlaps with DL Sub-band #1 901 in OFDM symbols 4 to 11 in the slot.

In the example of FIG. 13, where the portion of the PUSCH 1001 for UE1 will collide with DL subband #3 903, that portion of the PUSCH resource 1001 is remapped to another UL frequency resource 1301 in the UL SBFD sub-band (i.e., UL subband #2 902) of the same slot. The PUSCH resource 1002 for UE2 will not collide with any DL sub-band, so UE2 is able to continuously transmit the PUSCH 1002 as originally allocated.

In some arrangements of embodiments of the present technique, the gNB indicates whether remapping of the collided portion involves such a collided portion being remapped to another frequency resource or not. In other words, the communications device may be configured to receive, from the wireless communications network (e.g., from the infrastructure equipment), a re-mapping control signal indicating either that the communications device is to perform the re-mapping procedure or that the wireless communications network (e.g., the infrastructure equipment/gNB) is to perform the re-mapping procedure. Here, for uplink signals where the communications device is to perform the re-mapping procedure, the re-mapping control signal may indicate whether or not the re-mapping procedure is to comprise the communications device shifting the at least the portion of the uplink transmission in frequency. Here, this indication of the re-mapping procedure comprising the communications device shifting the at least the portion of the uplink transmission in frequency may apply to both the whole uplink transmission or to the colliding portion of UL transmission, and this may be specifically indicated by gNB either in this re-mapping control signal or in a separate indication (e.g. a semi-static configuration), may be determined by the UE based on other information or parameter values, or set in the specifications, etc. Here, this shifting in frequency may be the shifting from the (previously defined) first set of resources to a second set of resources which are within a second frequency range different to the first frequency range.

The indication may directly indicate the other frequency resource (i.e., second set of resources). In other words, the re-mapping control signal may be received (e.g., via semi-static signalling) from the wireless communications network (e.g., from the infrastructure equipment/gNB) and may comprise an indication of a second set of resources of the wireless radio interface to which the at least the portion of the uplink transmission is to be shifted by the communications device, the second set of resources being within a second frequency range different to the first frequency range. Correspondingly, for downlink signals transmitted by the network, the re-mapping control signal may be received via semi-static signalling from the wireless communications network (e.g., from the infrastructure equipment/gNB) and may comprise an indication of a second set of resources of the wireless radio interface to which the at least the portion of the downlink transmission is to be shifted by the wireless communications network (e.g., the infrastructure equipment/gNB), the second set of resources being within a second frequency range different to the first frequency range.

The indication may also or alternatively signal an offset (e.g., N_RB_Offset) from the original PUSCH or PUCCH allocation. Assuming that the UE knows in advance the location of the DL sub-band, as it may be semi-statically configured for example, the UE shifts the PUSCH resource by the amount indicated by the offset (which may be a negative or positive shift) in terms of number of PRBs or the like. In other words, the re-mapping control signal may comprise an indication of an offset, the offset indicating a frequency amount by which the communications device is to shift the at least the portion of the uplink transmission. Correspondingly, for downlink signals transmitted by the network, the re-mapping control signal may comprise an indication of an offset, the offset indicating a frequency amount by which the wireless communications network (e.g., the infrastructure equipment/gNB) is to shift the at least the portion of the downlink transmission.

For example in FIG. 13, UE1 is indicated with N_RB_Offset 1325 and UE1 shifts that part of the PUSCH 1001 to another frequency resource 1301, where such frequency resources are within the UL sub-band #2 902.

In some arrangements of embodiments of the present technique, if the network does not indicate any such remapping, the UE drops the portion that collides with a sub-band in the opposite direction. In other words, if the re-mapping control signal indicates that the re-mapping procedure is not to comprise the communications device shifting the at least the portion of the uplink transmission in frequency, the re-mapping procedure may comprise dropping the portion of the uplink transmission, and the communications device may be configured to transmit the uplink transmission without the dropped portion of the uplink transmission. Correspondingly, for downlink signals transmitted by the network, if the re-mapping control signal indicates that the re-mapping procedure is not to comprise the wireless communications network (e.g., the infrastructure equipment/gNB) shifting the at least the portion of the downlink transmission in frequency, the communications device may be configured to determine that the re-mapping procedure is to comprise the wireless communications network (e.g., the infrastructure equipment/gNB) dropping the portion of the downlink transmission, and the communications device may be configured to receive the downlink transmission without the dropped portion of the downlink transmission.

An example of this is also shown in FIG. 13, where UE3's PUSCH transmission 1003 will collide with DL subband #1 901, and here the gNB did not indicate that the PUSCH resource is to be remapped to another UL resource. Hence, UE3 drops the part of PUSCH transmission 1003 that overlaps with DL subband #1 901.

Here, as mentioned above, in some arrangements, the portion of the uplink transmission that is dropped may be one (or more) of a number of repetitions of an uplink signal transmitted by the communications device. In other words, the uplink transmission may consist of a plurality of repetitions of an uplink signal, and the re-mapping procedure comprises dropping one or more of the repetitions of the uplink signal. In some other arrangements, if there is a collision, the UE may drop the whole uplink transmission. In other words, the re-mapping procedure comprises dropping the entire uplink transmission. Those skilled in the art would appreciate that no uplink transmission at all would then be performed by the communications device.

In some arrangements of embodiments of the present technique, if a transmission is remapped due to a collision with a sub-band in the opposite direction, the entire transmission is shifted. In other words, the re-mapping procedure may comprise shifting the entire uplink or downlink transmission to a second set of resources of the wireless radio interface, the second set of resources being within a second frequency range different (in frequency but not time) to the first frequency range. Correspondingly, for downlink signals transmitted by the network, the re-mapping control signal may indicate that the re-mapping procedure is to comprise the wireless communications network (e.g., the infrastructure equipment/gNB) shifting the entire downlink transmission in frequency. This recognises that shifting a portion of a transmission would disrupt the frequency phase continuity and the portion that is shifted may require additional DMRS.

An example is shown in FIG. 14, where a slot is configured with SBFD consisting of two UL sub-bands (i.e., Sub-band #1 1401 and Sub-band #3 1403) and one DL sub-band (i.e., Sub-band #2 1402) in OFDM symbols 4 to 11 of the slot, whilst OFDM symbols 0, 1, 2, 3, 12 and 13 are fully uplink. Here, while a PDSCH 1410 transmitted by the network to UE1 occupying the entire slot, but with a portion of the PDSCH 1410 overlapping with UL Sub-band #2 1402 in OFDM symbols 4 to 11 in the slot. Here, UE1 shifts the entire PDSCH 1410 (rather than just the colliding portion) to a different frequency location 1420. UE1 may shift the PDSCH 1410 to the different frequency location 1420 by amount defined by N_RB_Offset 1425.

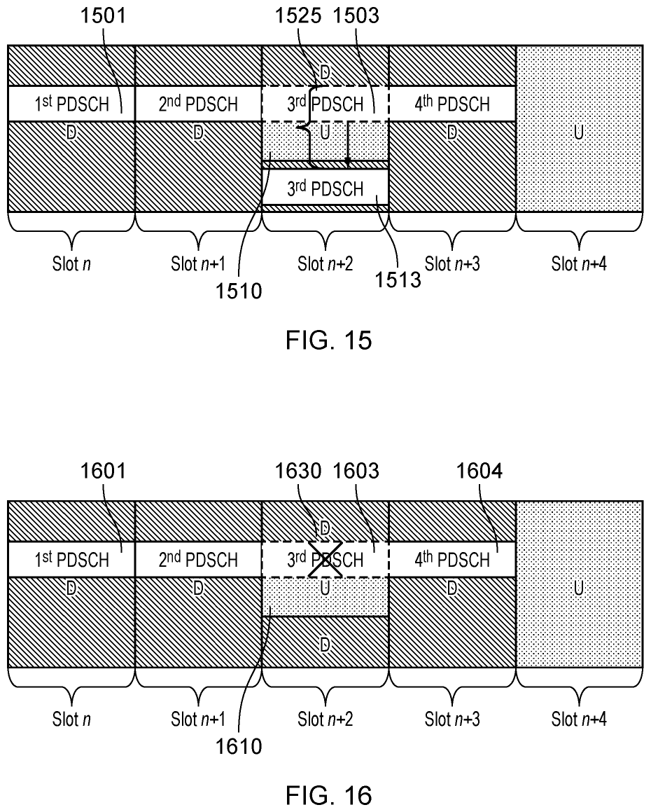

Another example is shown in FIG. 15, where a UE is scheduled to receive a PDSCH 1501 with four repetitions that starts at Slot n and ends at Slot n+3. The third PDSCH repetition 1503 collides partially with an UL sub-band 1510 and, as per such arrangements, the third PDSCH repetition 1503 is therefore shifted by a predetermined frequency offset N_RB_Offset 1525, which in this case, causes it to be shifted to a location 1513 within a DL sub-band.

In some arrangements of embodiments of the present technique, if a downlink transmission or repetition is not configured or indicated to be remapped, and that downlink transmission or repetition collides with a sub-band in the uplink, that downlink transmission or repetition is dropped. In other words, if the re-mapping control signal indicates that the re-mapping procedure is not to comprise the wireless communications network (e.g., the infrastructure equipment/gNB) shifting the at least the portion (where a portion may refer to a single repetition) of the downlink transmission in frequency, the communications device may be configured to determine that the re-mapping procedure is to comprise the wireless communications network (e.g. the infrastructure equipment/gNB) dropping (either the portion of or the whole of) the downlink transmission, and-if a portion of the downlink transmission is dropped rather than the entire downlink transmission-the receiving the downlink transmission may then comprise receiving the downlink transmission without the dropped portion of the downlink transmission. Here, where the portion of the downlink transmission corresponds to one (or more) of a plurality of repetitions of a downlink signal, the communications device may be configured to determine that the re-mapping procedure is to comprise the wireless communications network (e.g. the infrastructure equipment/gNB) dropping one or more of the repetitions of the downlink signal.

An example is shown in FIG. 16 where-similarly to the example of FIG. 15—a PSDCH 1601 is scheduled to be received by a UE with four repetitions starting at Slot n. The third PDSCH repetition 1603 (partially) collides with an UL sub-band 1610 in Slot n+2 and as per such arrangements, the third PDSCH repetition is therefore dropped 1630. The PDSCH repetition continues in Slot n+3 where the fourth PDSCH 1604 is transmitted by the network to the UE since it does not collide with any UL sub-band. The UE receiving the PDSCH will therefore not combine the third PDSCH repetition 1603 with the other PDSCH repetitions.

In case of semi-statically configured resources with some set or dynamically configured periodicity-such as CG-PUSCH, SPS PDSCH and PUCCH-and if these resources collide with DL non-SBFD or UL non-SBFD symbols/slots, and if there is at least one UL SBFD sub-band or DL sub-band available on the same BWP that can carry the transmission, then the UE may receive an indication/signalling in advance from the network as to whether the transmission is to be dropped or is to be remapped to another frequency resource in the available SBFD sub-band on the same slot. In other words, the first set of resources may be periodic pre-configured resources indicated to the communications device via semi-static signalling received from the wireless communications network (e.g., from the infrastructure equipment/gNB). Here, the indicated second set of resources may be within a same bandwidth part, BWP, as the first set of resources.

In some arrangements of embodiments of the present technique, the network indicates semi-statically to the UE in advance (e.g., via RRC signalling) as to where CG-PUSCH, SPS PDSCH and PUCCH resources are remapped (see further arrangements of embodiments of the present technique regarding N_RB_Offset below). In other words, the re-mapping control signal may be received via semi-static signalling from the wireless communications network (e.g., from the infrastructure equipment/gNB).

In some arrangements of embodiments of the present technique, the indication is that the UE is configured supplementary CG-PUSCH, SPS PDSCH or PUCCH resources semi-statically in the UL SBFD sub-band or DL sub-band to use when a collision occurs. In other words, the indicated second set of resources may be supplementary periodic pre-configured resources. This is possible as the gNB can work out in advance when the collision will occur, and hence, can allocate the supplementary frequency resources in the UL SBFD or DL sub-band for re-mapping.

As shown in the example of FIG. 17, the (configured grant) PUSCH resources 1711 for UE1 and the (configured grant) PUSCH resources 1712 for UE2 collide with DL subband #3 1703 and DL subband #1 1701 respectively. Because of this, the gNB has already allocated supplementary resources (e.g., supplementary resources 1721 for UE1 and supplementary resources 1722 for UE2) in UL subband #2 1702 and the UEs are therefore able to use those resources for the transmission of the colliding portions of their PUSCH transmissions. It should be appreciated here that such arrangements are not restricted to only PUSCH transmissions as illustrated in the example in FIG. 17, and that they also apply to other transmissions such as PUCCH (in UL) and PDSCH (in DL).

In some arrangements of embodiments of the present technique, the supplementary CG-PUSCH or PUCCH resources are located in another BWP, and UE can autonomously switch to that BWP to transmit the CG-PUSCH, SPS PDSCH or PUCCH. In other words, the indicated second set of resources may be within a different BWP to the first set of resources.

In some arrangements of embodiments of the present technique, the indication is dynamically signalled by the DCI that scheduled the PUSCH, PUCCH or PDSCH resource in the first time. That is, the said signal with the N_RB_Offset or specifically indicated frequency resource to shift to may be indicated to the UE in a dynamic manner. In other words, the re-mapping control signal may be received via dynamic signalling from the wireless communications network (e.g., from the infrastructure equipment/gNB).

This said DCI can be an UL grant (for a PUSCH), a DL grant for a PUCCH and/or a PDSCH and an activation (or de-activation) DCI for CG-PUSCH or SPS PDSCH resources.

In some arrangements of embodiments of the present technique, the offset is a list of RRC configured values, but one value may be dynamically signalled by the scheduling DCI using one or more bits; for example 2-bits can be used to select one value from four possible values. In other words, the re-mapping control signal comprises an indication of an offset from among a plurality of pre-configured offsets, the indicated offset indicating a frequency amount by which the communications device is to shift the at least the portion of the uplink transmission. Correspondingly, for downlink signals transmitted by the network, the re-mapping control signal may comprise an indication of an offset from among a plurality of pre-configured offsets, the indicated offset indicating a frequency amount by which the wireless communications network (e.g., the infrastructure equipment/gNB) is to shift the at least the portion of the downlink transmission. This dynamic signalling will allow the avoidance of collisions with other transmissions to or transmissions from other UEs which need to be adjusted with respect to an offset as well, since those other UEs can be dynamically signalled with a different value from those (for example, four) values.

In some arrangements of embodiments of the present technique, the offset may be semi-statically (e.g. RRC) configured, and the UE may apply the offset if it determines that its DL or UL transmissions collides with UL or DL sub-bands.

In some arrangements of embodiments of the present technique, the said offset is calculated based on information defined in the specifications or parameters signalled to the UE. That is, the said N_RB_Offset is calculated for example based on the configuration of the sub-bands. In other words, the communications device may be configured to determine, based on a value of at least one parameter indicated to the communications device by the wireless communications network (e.g., the infrastructure equipment/gNB) or based on a value of at least one parameter which is pre-configured and known to the communications device, that the communications device is to perform the re-mapping procedure by shifting the at least the portion of the uplink transmission to a second set of resources of the wireless radio interface, the second set of resources being within a second frequency range different to the first frequency range. Here, where the second frequency range is defined as being “different” to the first frequency range, this may in some arrangements mean that the first and second frequency ranges have no resources in common, or may in some other arrangements mean that the first and second frequency ranges at least partially overlap in time and frequency. Correspondingly, for downlink signals transmitted by the network, the communications device may be configured to determine, based on a value of at least one parameter indicated to the communications device by the wireless communications network (e.g., the infrastructure equipment/gNB) or based on a value of at least one parameter which is pre-configured and known to the communications device, that the wireless communications network (e.g., the infrastructure equipment/gNB) is to perform the re-mapping procedure by shifting the at least the portion of the downlink transmission to a second set of resources of the wireless radio interface, the second set of resources being within a second frequency range different to the first frequency range. Likewise, as for the shifting of (at least a portion of) an uplink transmission as described above, here, where the second frequency range is defined as being “different” to the first frequency range, this may in some arrangements mean that the first and second frequency ranges have no resources in common, or may in some other arrangements mean that the first and second frequency ranges at least partially overlap in time and frequency. Here, the value of the parameter may indicate the location second set of resources or the offset as previously described, but may furthermore itself indicate (explicitly or implicitly) that the re-mapping is to be applied.

In some arrangements of embodiments of the present technique, the said offset is calculated by reflecting the scheduled transmissions over a Reflection Point (which may be known to the UE, or indicated dynamically or semi-statically to the UE by the gNB). In other words, the communications device may be configured to determine that the communications device is to perform the re-mapping procedure by shifting the at least the portion of the uplink transmission to a second set of resources of the wireless radio interface, the second set of resources being within a second frequency range different to the first frequency range, wherein the communications device may be configured to determine the second set of resources by reflecting the first set of resources across a line of reflection. Correspondingly, for downlink signals transmitted by the network, the communications device may be configured to determine that the wireless communications network (e.g., the infrastructure equipment/gNB) is to perform the re-mapping procedure by shifting the at least the portion of the downlink transmission to a second set of resources of the wireless radio interface, the second set of resources being within a second frequency range different to the first frequency range, and the communications device may be configured to determine the second set of resources by reflecting the first set of resources across a line of reflection.

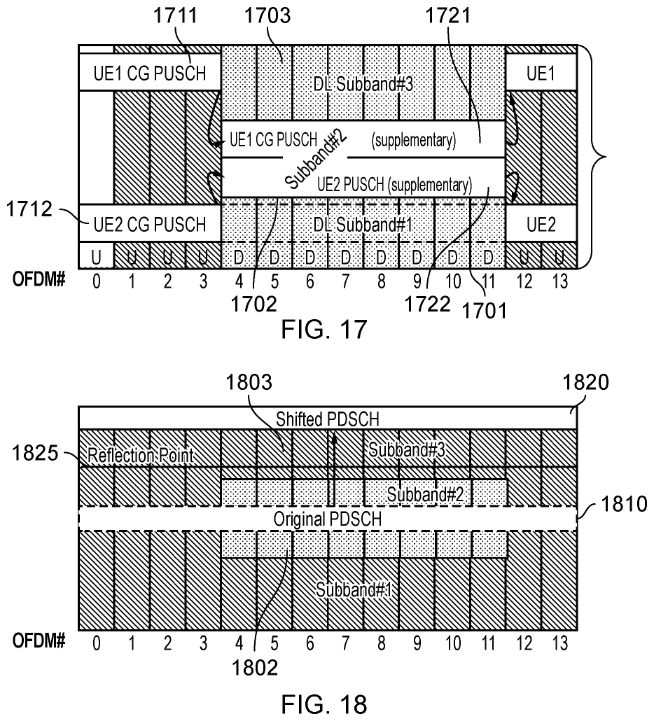

An example is shown in FIG. 18, where a PDSCH 1810, such as a PDSCH transmitted at an SPS occasion or a repetition of a dynamic PDSCH, is originally scheduled for the gNB to transmit in RBs that collide with an UL sub-band #2 1802 in OFDM symbols 4 to 11. As per such arrangements, the PDSCH is “reflected” over a Reflection Point 1825 as shown in FIG. 18, thereby occupying a new set of RBs 1820 that are within the upper DL sub-band #3 1803. The said Reflection Point 1825 can be RRC configured or can be indicated in a DCI such as a DL grant, UL grant or activation (or de-activation) DCI. In some arrangements of embodiments of the present technique, the UE autonomously decides whether to remap a DL or UL transmission by determining whether that transmission collides with a sub-band in the opposite direction. In other words, the communications device may be configured to perform, based on the determining that the portion of the uplink transmission at least partially overlaps in time and frequency with the one or more resource units configured for the transmission of downlink transmissions within the first frequency range, the re-mapping procedure on the at least the portion of the uplink transmission by shifting the at least the portion of the uplink transmission to a second set of resources of the wireless radio interface, the second set of resources being within a second frequency range different to the first frequency range. Correspondingly, for downlink signals transmitted by the network, the communications device may be configured to determine, based on the determining that the portion of the downlink transmission at least partially overlaps in time and frequency with the one or more resource units configured for the transmission of uplink transmissions within the first frequency range, that the wireless communications network (e.g. the infrastructure equipment/gNB) is to perform the re-mapping procedure on the at least the portion of the downlink transmission by shifting the at least the portion of the downlink transmission to a second set of resources of the wireless radio interface, the second set of resources being within a second frequency range different to the first frequency range.

Such arrangements are beneficial for semi-statically configured transmissions that occur periodically, such as CG-PUSCH, SPS PDSCH and PUCCH associated with SPS PDSCH. These arrangements recognise that the gNB may not be able to dynamically indicate every transmission occasion (e.g., a CG-PUSCH or SPS PDSCH occasion) which may or may not need to be remapped, and so such arrangements enable the UE to determine the need to remap autonomously for each transmission occasion. The N RB Offset used for such remapping can be signalled or calculated as per previously described arrangements of embodiments of the present technique.

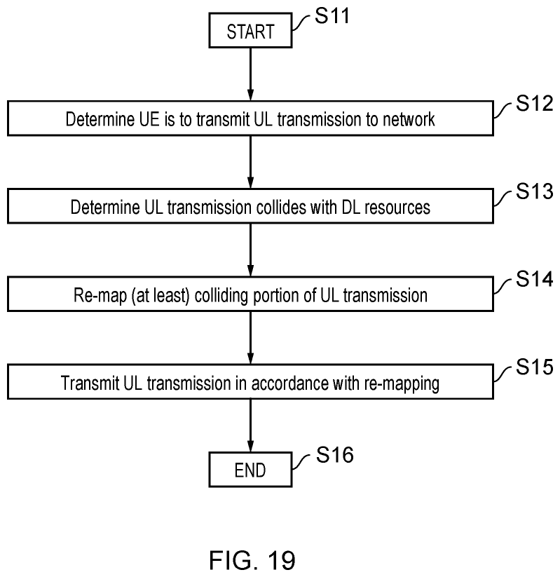

FIG. 19 shows a flow diagram illustrating a first example process of communications in a communications system in accordance with embodiments of the present technique. The process shown by FIG. 19 is a method of operating a communications device.

The method begins in step S11. The method comprises, in step S12, determining that the communications device is to transmit an uplink transmission to a wireless communications network at least partially within a first set of resources of a wireless radio interface, the first set of resources being within a first frequency range. In step S13, the method comprises determining that a portion of the uplink transmission at least partially overlaps in time and frequency with one or more resource units configured for the transmission of downlink transmissions within the first frequency range. Then, in step S14, the process comprises performing a re-mapping procedure on at least the portion of the uplink transmission. Following this, in step S15, the method comprises transmitting, after performing the re-mapping procedure, the uplink transmission to the wireless communications network. The process ends in step S16.

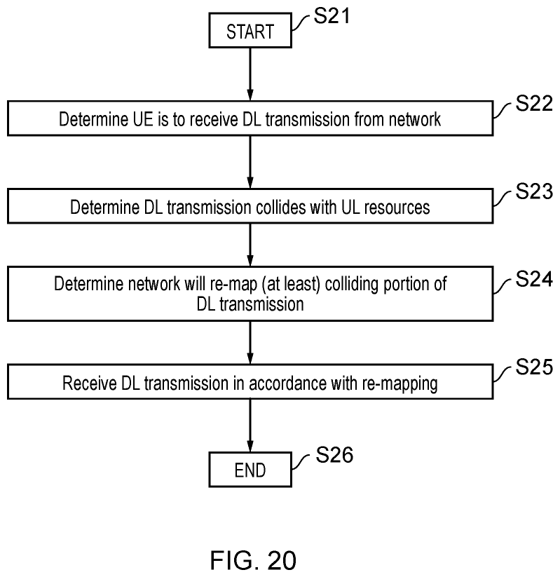

FIG. 20 shows a flow diagram illustrating a second example process of communications in a communications system in accordance with embodiments of the present technique. The process shown by FIG. 20 is a method of operating a communications device.

The method begins in step S21. The method comprises, in step S22, determining that the communications device is to receive a downlink transmission from a wireless communications network at least partially within a first set of resources of a wireless radio interface, the first set of resources being within a first frequency range. In step S23, the method comprises determining that a portion of the downlink transmission at least partially overlaps in time and frequency with one or more resource units configured for the transmission of uplink transmissions within the first frequency range. Then, in step S24, the process comprises determining that the wireless communications network is to perform a re-mapping procedure on at least the portion of the downlink transmission. Following this, in step S25, the method comprises receiving, in accordance with the determined re-mapping procedure, the downlink transmission from the wireless communications network. The process ends in step S26.

Those skilled in the art would appreciate that the methods shown by FIGS. 19 and 20 may be adapted in accordance with embodiments of the present technique. For example, other intermediate steps may be included in such methods, or the steps may be performed in any logical order. Though embodiments of the present technique have been described largely by way of the example communications systems shown in FIGS. 11 and 12 (and further discussed with respect to the examples of FIGS. 13 to 18), it would be clear to those skilled in the art that they could be equally applied to other systems to those described herein. Here, those skilled in the art would appreciate that-in so far as they are technically feasible-all arrangements described herein where UL transmissions (such as PUSCH or PUCCH transmissions) collide with DL resources are correspondingly applicable for where DL transmissions (such as PDSCH or PDCCH transmissions) collide with UL resources, and vice versa.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device, the method comprising
determining that the communications device is to transmit an uplink transmission to a wireless communications network at least partially within a first set of resources of a wireless radio interface, the first set of resources being within a first frequency range,
   determining that a portion of the uplink transmission at least partially overlaps in time and frequency with one or more resource units configured for the transmission of downlink transmissions within the first frequency range,
   performing a re-mapping procedure on at least the portion of the uplink transmission, and
   transmitting, after performing the re-mapping procedure, the uplink transmission to the wireless communications network.
Paragraph 2. A method according to Paragraph 1, wherein the re-mapping procedure comprises shifting only the portion of the uplink transmission to a second set of resources of the wireless radio interface, the second set of resources being within a second frequency range different to the first frequency range.
Paragraph 3. A method according to Paragraph 1 or Paragraph 2, wherein the re-mapping procedure comprises shifting the entire uplink transmission to a second set of resources of the wireless radio interface, the second set of resources being within a second frequency range different to the first frequency range.
Paragraph 4. A method according to any of Paragraphs 1 to 3, wherein the re-mapping procedure comprises dropping the portion of the uplink transmission, and the transmitting the uplink transmission comprises transmitting the uplink transmission without the dropped portion of the uplink transmission.
Paragraph 5. A method according to any of Paragraphs 1 to 4, wherein the re-mapping procedure comprises dropping the entire uplink transmission.
Paragraph 6. A method according to any of Paragraphs 1 to 5, wherein the uplink transmission consists of a plurality of repetitions of an uplink signal, and the re-mapping procedure comprises dropping one or more of the repetitions of the uplink signal.
Paragraph 7. A method according to any of Paragraphs 1 to 6, comprising
receiving, from the wireless communications network, a re-mapping control signal indicating that the communications device is to perform the re-mapping procedure, and wherein the re-mapping control signal indicates whether or not the re-mapping procedure is to comprise the communications device shifting the at least the portion of the uplink transmission in frequency.
Paragraph 8. A method according to Paragraph 7, wherein, if the re-mapping control signal indicates that the re-mapping procedure is not to comprise the communications device shifting the at least the portion of the uplink transmission in frequency, the re-mapping procedure comprises dropping the portion of the uplink transmission, and the transmitting the uplink transmission comprises transmitting the uplink transmission without the dropped portion of the uplink transmission.
Paragraph 9. A method according to Paragraph 7 or Paragraph 8, wherein the re-mapping control signal comprises an indication of an offset, the offset indicating a frequency amount by which the communications device is to shift the at least the portion of the uplink transmission.
Paragraph 10. A method according to any of Paragraphs 7 to 9, wherein the re-mapping control signal is received via dynamic signalling from the wireless communications network.
Paragraph 11. A method according to Paragraph 10, wherein the re-mapping control signal comprises an indication of an offset from among a plurality of pre-configured offsets, the indicated offset indicating a frequency amount by which the communications device is to shift the at least the portion of the uplink transmission.
Paragraph 12. A method according to any of Paragraphs 7 to 9, wherein the re-mapping control signal is received via semi-static signalling from the wireless communications network.
Paragraph 13. A method according to any of Paragraphs 7 to 12, wherein the first set of resources are periodic pre-configured resources indicated to the communications device via semi-static signalling received from the wireless communications network.
Paragraph 14. A method according to Paragraph 13, wherein the re-mapping control signal is received via semi-static signalling from the wireless communications network and comprises an indication of a second set of resources of the wireless radio interface to which the at least the portion of the uplink transmission is to be shifted by the communications device, the second set of resources being within a second frequency range different to the first frequency range.
Paragraph 15. A method according to Paragraph 14, wherein the indicated second set of resources are within a same bandwidth part, BWP, as the first set of resources.
Paragraph 16. A method according to Paragraph 14 or Paragraph 15, wherein the indicated second set of resources are supplementary periodic pre-configured resources.
Paragraph 17. A method according to Paragraph 16, wherein the indicated second set of resources are within a different BWP to the first set of resources Paragraph 18. A method according to any of Paragraphs 1 to 17, comprising
   determining, based on a value of at least one parameter indicated to the communications device by the wireless communications network, that the communications device is to perform the re-mapping procedure by shifting the at least the portion of the uplink transmission to a second set of resources of the wireless radio interface, the second set of resources being within a second frequency range different to the first frequency range.
Paragraph 19. A method according to any of Paragraphs 1 to 18, comprising
   determining, based on a value of at least one parameter which is pre-configured and known to the communications device, that the communications device is to perform the re-mapping procedure by shifting the at least the portion of the uplink transmission to a second set of resources of the wireless radio interface, the second set of resources being within a second frequency range different to the first frequency range.
Paragraph 20. A method according to any of Paragraphs 1 to 19, comprising
   determining that the communications device is to perform the re-mapping procedure by shifting the at least the portion of the uplink transmission to a second set of resources of the wireless radio interface, the second set of resources being within a second frequency range different to the first frequency range, wherein the method comprises
   determining the second set of resources by reflecting the first set of resources across a line of reflection.
Paragraph 21. A method according to any of Paragraphs 1 to 20, comprising
   performing, based on the determining that the portion of the uplink transmission at least partially overlaps in time and frequency with the one or more resource units configured for the transmission of downlink transmissions within the first frequency range, the re-mapping procedure on the at least the portion of the uplink transmission by shifting the at least the portion of the uplink transmission to a second set of resources of the wireless radio interface, the second set of resources being within a second frequency range different to the first frequency range.
Paragraph 22. A method according to any of Paragraphs 1 to 21, wherein the one or more resource units configured for the transmission of downlink transmissions within the first frequency range form a downlink sub-band within a specified time period, wherein the downlink sub-band is adjacent to one or more uplink sub-bands within the specified time period.
Paragraph 23. A communications device comprising
   transceiver circuitry, and
   controller circuitry configured in combination with the transceiver circuitry
   to determine that the communications device is to transmit an uplink transmission to a wireless communications network at least partially within a first set of resources of a wireless radio interface, the first set of resources being within a first frequency range,
   to determine that a portion of the uplink transmission at least partially overlaps in time and frequency with one or more resource units configured for the transmission of downlink transmissions within the first frequency range,
   to perform a re-mapping procedure on at least the portion of the uplink transmission, and
   to transmit, after performing the re-mapping procedure, the uplink transmission to the wireless communications network.
Paragraph 24. Circuitry for a communications device comprising
   transceiver circuitry, and
   controller circuitry configured in combination with the transceiver circuitry
   to determine that the communications device is to transmit an uplink transmission to a wireless communications network at least partially within a first set of resources of a wireless radio interface, the first set of resources being within a first frequency range,
   to determine that a portion of the uplink transmission at least partially overlaps in time and frequency with one or more resource units configured for the transmission of downlink transmissions within the first frequency range,
   to perform a re-mapping procedure on at least the portion of the uplink transmission, and
   to transmit, after performing the re-mapping procedure, the uplink transmission to the wireless communications network.
Paragraph 25. A method of operating an infrastructure equipment forming part of a first wireless communications network, the method comprising
   transmitting, to a communications device, a re-mapping control signal indicating that the communications device is to perform a re-mapping procedure on at least a portion of an uplink transmission to be received by the infrastructure equipment from the communications device at least partially within a first set of resources of a wireless radio interface provided by the infrastructure equipment, the first set of resources being within a first frequency range, wherein the portion of the uplink transmission at least partially overlaps in time and frequency with one or more resource units configured for the transmission of downlink transmissions within the first frequency range, and
   receiving, in accordance with the determined re-mapping procedure, the uplink transmission from the communications device.
Paragraph 26. A method according to Paragraph 25, wherein the re-mapping control signal indicates that the re-mapping procedure is not to comprise the communications device shifting the at least the portion of the uplink transmission in frequency, and the method comprises
   determining that the re-mapping procedure is to comprise the communications device dropping the portion of the uplink transmission, and wherein the receiving the uplink transmission comprises receiving the uplink transmission without the dropped portion of the uplink transmission.
Paragraph 27. A method according to Paragraph 25 or Paragraph 26, wherein the re-mapping control signal indicates that the re-mapping procedure is not to comprise the communications device shifting the at least the portion of the uplink transmission in frequency, and the method comprises
   determining that the re-mapping procedure is to comprise the communications device dropping the entire uplink transmission.
Paragraph 28. A method according to any of Paragraphs 25 to 27, wherein the uplink transmission consists of a plurality of repetitions of an uplink signal and the re-mapping control signal indicates that the re-mapping procedure is not to comprise the communications device shifting the at least the portion of the uplink transmission in frequency, and the method comprises
   determining that the re-mapping procedure is to comprise the communications device dropping
Paragraph 29. A method according to any of Paragraphs 25 to 28, wherein the re-mapping control signal indicates that the re-mapping procedure is to comprise the communications device shifting only the portion of the uplink transmission in frequency.
Paragraph 30. A method according to any of Paragraphs 25 to 29, wherein the re-mapping control signal indicates that the re-mapping procedure is to comprise the communications device shifting the entire uplink transmission in frequency.
Paragraph 31. A method according to any of Paragraphs 25 to 30, wherein the re-mapping control signal comprises an indication of an offset, the offset indicating a frequency amount by which the communications device is to shift the at least the portion of the uplink transmission.
Paragraph 32. A method according to any of Paragraphs 25 to 31, wherein the re-mapping control signal is transmitted by the infrastructure equipment to the communications device via dynamic signalling.
Paragraph 33. A method according to Paragraph 32, wherein the re-mapping control signal comprises an indication of an offset from among a plurality of pre-configured offsets, the indicated offset indicating a frequency amount by which the communications device is to shift the at least the portion of the uplink transmission.
Paragraph 34. A method according to any of Paragraphs 25 to 33, wherein the re-mapping control signal is transmitted by the infrastructure equipment to the communications device via semi-static signalling.
Paragraph 35. A method according to any of Paragraphs 25 to 34, wherein the first set of resources are periodic pre-configured resources indicated in semi-static signalling transmitted by the infrastructure equipment to the communications device.
Paragraph 36. A method according to Paragraph 35, wherein the re-mapping control signal is transmitted by the infrastructure equipment to the communications device via semi-static signalling and comprises an indication of a second set of resources of the wireless radio interface to which the at least the portion of the uplink transmission is to be shifted by the communications device, the second set of resources being within a second frequency range different to the first frequency range.
Paragraph 37. A method according to Paragraph 36, wherein the indicated second set of resources are within a same bandwidth part, BWP, as the first set of resources.
Paragraph 38. A method according to Paragraph 36 or Paragraph 37, wherein the indicated second set of resources are supplementary periodic pre-configured resources.
Paragraph 39. A method according to Paragraph 38, wherein the indicated second set of resources are within a different BWP to the first set of resources.
Paragraph 40. A method according to any of Paragraphs 25 to 39, wherein the one or more resource units configured for the transmission of downlink transmissions within the first frequency range form a downlink sub-band within a specified time period, wherein the downlink sub-band is adjacent to one or more uplink sub-bands within the specified time period.
Paragraph 41. An infrastructure equipment forming part of a first wireless communications network, the infrastructure equipment comprising
   transceiver circuitry, and
   controller circuitry configured in combination with the transceiver circuitry
   to transmit, to a communications device, a re-mapping control signal indicating that the communications device is to perform a re-mapping procedure on at least a portion of an uplink transmission to be received by the infrastructure equipment from the communications device at least partially within a first set of resources of a wireless radio interface provided by the infrastructure equipment, the first set of resources being within a first frequency range, wherein the portion of the uplink transmission at least partially overlaps in time and frequency with one or more resource units configured for the transmission of downlink transmissions within the first frequency range, and
   to receive, in accordance with the determined re-mapping procedure, the uplink transmission from the communications device.
Paragraph 42. Circuitry for an infrastructure equipment forming part of a first wireless communications network, the infrastructure equipment comprising
   transceiver circuitry, and
   controller circuitry configured in combination with the transceiver circuitry
   to transmit, to a communications device, a re-mapping control signal indicating that the communications device is to perform a re-mapping procedure on at least a portion of an uplink transmission to be received by the infrastructure equipment from the communications device at least partially within a first set of resources of a wireless radio interface provided by the infrastructure equipment, the first set of resources being within a first frequency range, wherein the portion of the uplink transmission at least partially overlaps in time and frequency with one or more resource units configured for the transmission of downlink transmissions within the first frequency range, and
   to receive, in accordance with the determined re-mapping procedure, the uplink transmission from the communications device.
Paragraph 43. A wireless communications system comprising a communications device according to Paragraph 23 and an infrastructure equipment according to Paragraph 41.
Paragraph 44. A method of operating a communications device, the method comprising
   determining that the communications device is to receive a downlink transmission from a wireless communications network at least partially within a first set of resources of a wireless radio interface, the first set of resources being within a first frequency range,
   determining that a portion of the downlink transmission at least partially overlaps in time and frequency with one or more resource units configured for the transmission of uplink transmissions within the first frequency range,
   determining that the wireless communications network is to perform a re-mapping procedure on at least the portion of the downlink transmission, and
   receiving, in accordance with the determined re-mapping procedure, the downlink transmission from the wireless communications network.
Paragraph 45. A method according to Paragraph 44, comprising
   receiving, from the wireless communications network, a re-mapping control signal indicating that the wireless communications network is to perform the re-mapping procedure.
Paragraph 46. A method according to Paragraph 45, wherein, if the re-mapping control signal indicates that the re-mapping procedure is not to comprise the wireless communications network shifting the at least the portion of the downlink transmission in frequency, the method comprises
   determining that the re-mapping procedure is to comprise the wireless communications network dropping the portion of the downlink transmission, and wherein the receiving the downlink transmission comprises receiving the downlink transmission without the dropped portion of the downlink transmission. Paragraph 47. A method according to Paragraph 45 or Paragraph 46, wherein the re-mapping control signal indicates that the re-mapping procedure is not to comprise the wireless communications network shifting the at least the portion of the downlink transmission in frequency, and the method comprises
   determining that the re-mapping procedure is to comprise the wireless communications network dropping the entire downlink transmission.
Paragraph 48. A method according to any of Paragraphs 45 to 47, wherein the downlink transmission consists of a plurality of repetitions of a downlink signal and the re-mapping control signal indicates that the re-mapping procedure is not to comprise the wireless communications network shifting the at least the portion of the downlink transmission in frequency, and the method comprises
   determining that the re-mapping procedure is to comprise the wireless communications network dropping one or more of the repetitions of the downlink signal.
Paragraph 49. A method according to any of Paragraphs 45 to 48, wherein the re-mapping control signal indicates that the re-mapping procedure is to comprise the wireless communications network shifting only
Paragraph 50. A method according to any of Paragraphs 45 to 49, wherein the re-mapping control signal indicates that the re-mapping procedure is to comprise the wireless communications network shifting the entire downlink transmission in frequency.
Paragraph 51. A method according to any of Paragraphs 45 to 50, wherein the re-mapping control signal comprises an indication of an offset, the offset indicating a frequency amount by which the wireless communications network is to shift the at least the portion of the downlink transmission.
Paragraph 52. A method according to any of Paragraphs 45 to 51, wherein the re-mapping control signal is received via dynamic signalling from the wireless communications network.
Paragraph 53. A method according to Paragraph 52, wherein the re-mapping control signal comprises an indication of an offset from among a plurality of pre-configured offsets, the indicated offset indicating a frequency amount by which the wireless communications network is to shift the at least the portion of the downlink transmission.
Paragraph 54. A method according to any of Paragraphs 45 to 51, wherein the re-mapping control signal is received via semi-static signalling from the wireless communications network.
Paragraph 55. A method according to any of Paragraphs 45 to 54, wherein the first set of resources are periodic pre-configured resources indicated to the communications device via semi-static signalling received from the wireless communications network.
Paragraph 56. A method according to Paragraph 55, wherein the re-mapping control signal is received via semi-static signalling from the wireless communications network and comprises an indication of a second set of resources of the wireless radio interface to which the at least the portion of the downlink transmission is to be shifted by the wireless communications network, the second set of resources being within a second frequency range different to the first frequency range.
Paragraph 57. A method according to Paragraph 56, wherein the indicated second set of resources are within a same bandwidth part, BWP, as the first set of resources.
Paragraph 58. A method according to Paragraph 56 or Paragraph 57, wherein the indicated second set of resources are supplementary periodic pre-configured resources.
Paragraph 59. A method according to Paragraph 58, wherein the indicated second set of resources are within a different BWP to the first set of resources
Paragraph 60. A method according to any of Paragraphs 44 to 59, comprising
   determining, based on a value of at least one parameter indicated to the communications device by the wireless communications network, that the wireless communications network is to perform the re-mapping procedure by shifting the at least the portion of the downlink transmission to a second set of resources of the wireless radio interface, the second set of resources being within a second frequency range different to the first frequency range.
Paragraph 61. A method according to any of Paragraphs 44 to 60, comprising
   determining, based on a value of at least one parameter which is pre-configured and known to the communications device, that the wireless communications network is to perform the re-mapping procedure by shifting the at least the portion of the downlink transmission to a second set of resources of the wireless radio interface, the second set of resources being within a second frequency range different to the first frequency range.
Paragraph 62. A method according to any of Paragraphs 44 to 61, comprising
   determining that the wireless communications network is to perform the re-mapping procedure by shifting the at least the portion of the downlink transmission to a second set of resources of the wireless radio interface, the second set of resources being within a second frequency range different to the first frequency range, wherein the method comprises
   determining the second set of resources by reflecting the first set of resources across a line of reflection.
Paragraph 63. A method according to any of Paragraphs 44 to 62, comprising
   determining, based on the determining that the portion of the downlink transmission at least partially overlaps in time and frequency with the one or more resource units configured for the transmission of uplink transmissions within the first frequency range, that the wireless communications network is to perform the re-mapping procedure on the at least the portion of the downlink transmission by shifting the at least the portion of the downlink transmission to a second set of resources of the wireless radio interface, the second set of resources being within a second frequency range different to the first frequency range.
Paragraph 64. A method according to any of Paragraphs 44 to 63, wherein the one or more resource units configured for the transmission of uplink transmissions within the first frequency range form an uplink sub-band within a specified time period, wherein the uplink sub-band is adjacent to one or more downlink sub-bands within the specified time period.
Paragraph 65. A communications device comprising
   transceiver circuitry, and
   controller circuitry configured in combination with the transceiver circuitry
   to determine that the communications device is to receive a downlink transmission from a wireless communications network at least partially within a first set of resources of a wireless radio interface, the first set of resources being within a first frequency range,
   to determine that a portion of the downlink transmission at least partially overlaps in time and frequency with one or more resource units configured for the transmission of uplink transmissions within the first frequency range,
   to determine that the wireless communications network is to perform a re-mapping procedure on at least the portion of the downlink transmission, and
   to receive, in accordance with the determined re-mapping procedure, the downlink transmission from the wireless communications network.
Paragraph 66. Circuitry for a communications device comprising
   transceiver circuitry, and
   controller circuitry configured in combination with the transceiver circuitry
   to determine that the communications device is to receive a downlink transmission from a wireless communications network at least partially within a first set of resources of a wireless radio interface, the first set of resources being within a first frequency range,
   to determine that a portion of the downlink transmission at least partially overlaps in time and frequency with one or more resource units configured for the transmission of uplink transmissions within the first frequency range,
   to determine that the wireless communications network is to perform a re-mapping procedure on at least the portion of the downlink transmission, and
   to receive, in accordance with the determined re-mapping procedure, the downlink transmission from the wireless communications network.
Paragraph 67. A method of operating an infrastructure equipment forming part of a first wireless communications network, the method comprising
   transmitting, to a communications device, a re-mapping control signal indicating that the infrastructure equipment is to perform a re-mapping procedure on at least a portion of a downlink transmission to be transmitted by the infrastructure equipment to the communications device at least partially within a first set of resources of a wireless radio interface provided by the infrastructure equipment, the first set of resources being within a first frequency range, wherein the portion of the downlink transmission at least partially overlaps in time and frequency with one or more resource units configured for the transmission of uplink transmissions within the first frequency range,
   performing the re-mapping procedure on at least the portion of the downlink transmission, and
   transmitting, after performing the re-mapping procedure, the downlink transmission to the
Paragraph 68. A method according to Paragraph 67, wherein the re-mapping control signal indicates that the re-mapping procedure is not to comprise the infrastructure equipment shifting the at least the portion of the downlink transmission in frequency, and the method comprises
   dropping the portion of the downlink transmission, wherein the transmitting the downlink transmission comprises transmitting the downlink transmission without the dropped portion of the downlink transmission.
Paragraph 69. A method according to Paragraph 67 or Paragraph 68, wherein the re-mapping control signal indicates that the re-mapping procedure is not to comprise the infrastructure equipment shifting the at least the portion of the downlink transmission in frequency, and the method comprises
   dropping the entire downlink transmission.
Paragraph 70. A method according to any of Paragraphs 67 to 69, wherein the downlink transmission consists of a plurality of repetitions of a downlink signal and the re-mapping control signal indicates that the re-mapping procedure is not to comprise the infrastructure equipment shifting the at least the portion of the downlink transmission in frequency, and the method comprises
   dropping one or more of the repetitions of the downlink signal.
Paragraph 71. A method according to any of Paragraphs 67 to 70, wherein the re-mapping control signal indicates that the re-mapping procedure is to comprise the infrastructure equipment shifting only the portion of the downlink transmission in frequency.
Paragraph 72. A method according to any of Paragraphs 67 to 71, wherein the re-mapping control signal indicates that the re-mapping procedure is to comprise the infrastructure equipment shifting the entire downlink transmission in frequency.
Paragraph 73. A method according to any of Paragraphs 67 to 72, wherein the re-mapping control signal comprises an indication of an offset, the offset indicating a frequency amount by which the infrastructure equipment is to shift the at least the portion of the downlink transmission.
Paragraph 74. A method according to any of Paragraphs 67 to 73, wherein the re-mapping control signal is transmitted by the infrastructure equipment to the communications device via dynamic signalling.
Paragraph 75. A method according to Paragraph 74, wherein the re-mapping control signal comprises an indication of an offset from among a plurality of pre-configured offsets, the indicated offset indicating a frequency amount by which the infrastructure equipment is to shift the at least the portion of the downlink transmission.
Paragraph 76. A method according to any of Paragraphs 67 to 75, wherein the re-mapping control signal is transmitted by the infrastructure equipment to the communications device via semi-static signalling.
Paragraph 77. A method according to any of Paragraphs 67 to 76, wherein the first set of resources are periodic pre-configured resources indicated in semi-static signalling transmitted by the infrastructure equipment to the communications device.
Paragraph 78. A method according to Paragraph 77, wherein the re-mapping control signal is transmitted by the infrastructure equipment to the communications device via semi-static signalling and comprises an indication of a second set of resources of the wireless radio interface to which the at least the portion of the downlink transmission is to be shifted by the infrastructure equipment, the second set of resources being within a second frequency range different to the first frequency range.
Paragraph 79. A method according to Paragraph 78, wherein the indicated second set of resources are within a same bandwidth part, BWP, as the first set of resources.
Paragraph 80. A method according to Paragraph 78 or Paragraph 79, wherein the indicated second set of resources are supplementary periodic pre-configured resources.
Paragraph 81. A method according to Paragraph 80, wherein the indicated second set of resources are within a different BWP to the first set of resources.
Paragraph 82. A method according to any of Paragraphs 67 to 81, wherein the one or more resource units configured for the transmission of uplink transmissions within the first frequency range form an uplink sub-band within a specified time period, wherein the uplink sub-band is adjacent to one or more downlink sub-bands within the specified time period.
Paragraph 83. An infrastructure equipment forming part of a first wireless communications network, the infrastructure equipment comprising
   transceiver circuitry, and
   controller circuitry configured in combination with the transceiver circuitry
   to transmit, to a communications device, a re-mapping control signal indicating that the infrastructure equipment is to perform a re-mapping procedure on at least a portion of a downlink transmission to be transmitted by the infrastructure equipment to the communications device at least partially within a first set of resources of a wireless radio interface provided by the infrastructure equipment, the first set of resources being within a first frequency range, wherein the portion of the downlink transmission at least partially overlaps in time and frequency with one or more resource units configured for the transmission of uplink transmissions within the first frequency range,
   to perform the re-mapping procedure on at least the portion of the downlink transmission, and
   to transmit, after performing the re-mapping procedure, the downlink transmission to the communications device.
Paragraph 84. Circuitry for an infrastructure equipment forming part of a first wireless communications network, the infrastructure equipment comprising
   transceiver circuitry, and
   controller circuitry configured in combination with the transceiver circuitry
   to transmit, to a communications device, a re-mapping control signal indicating that the infrastructure equipment is to perform a re-mapping procedure on at least a portion of a downlink transmission to be transmitted by the infrastructure equipment to the communications device at least partially within a first set of resources of a wireless radio interface provided by the infrastructure equipment, the first set of resources being within a first frequency range, wherein the portion of the downlink transmission at least partially overlaps in time and frequency with one or more resource units configured for the transmission of uplink transmissions within the first frequency range,
   to perform the re-mapping procedure on at least the portion of the downlink transmission, and
   to transmit, after performing the re-mapping procedure, the downlink transmission to the communications device.
Paragraph 85. A wireless communications system comprising a communications device according to Paragraph 65 and an infrastructure equipment according to Paragraph 83.
Paragraph 86. A computer program comprising instructions which, when loaded onto a computer, cause the computer to perform a method according to any of Paragraphs 1 to 22, Paragraphs 25 to 40, Paragraphs 44 to 64, or Paragraph 67 to 82.
Paragraph 87. A non-transitory computer-readable storage medium storing a computer program according to Paragraph 86.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

Holma H. and Toskala A, “LTE for UMTS OFDMA and SC-FDMA based radio access”, John Wiley and Sons, 2009.

TR 38.913, “Study on Scenarios and Requirements for Next Generation Access Technologies (Release 14)”, 3rd Generation Partnership Project, v 14.3.0, August 2017.

RP-213591, “New SI: Study on evolution of NR duplex operation,” CMCC, RAN #94e, December 2021.

RP-220633, “Revised SID: Study on evolution of NR duplex operation,” CMCC, RAN #95e, March 2022.

European U.S. Pat. No. 3,545,716.

1. A method of operating a communications device, the method comprising
determining that the communications device is to transmit an uplink transmission to a wireless communications network at least partially within a first set of resources of a wireless radio interface, the first set of resources being within a first frequency range,
determining that a portion of the uplink transmission at least partially overlaps in time and frequency with one or more resource units configured for the transmission of downlink transmissions within the first frequency range,
performing a re-mapping procedure on at least the portion of the uplink transmission, and
transmitting, after performing the re-mapping procedure, the uplink transmission to the wireless communications network.

2. (canceled)

3. A method according to claim 1, wherein the re-mapping procedure comprises shifting the entire uplink transmission to a second set of resources of the wireless radio interface, the second set of resources being within a second frequency range different to the first frequency range.

4.-6. (canceled)

7. A method according to claim 1, comprising
receiving, from the wireless communications network, a re-mapping control signal indicating that the communications device is to perform the re-mapping procedure, and wherein the re-mapping control signal indicates whether or not the re-mapping procedure is to comprise the communications device shifting the at least the portion of the uplink transmission in frequency.

8. (canceled)

9. A method according to claim 7, wherein the re-mapping control signal comprises an indication of an offset, the offset indicating a frequency amount by which the communications device is to shift the at least the portion of the uplink transmission.

10. A method according to claim 7, wherein the re-mapping control signal is received via dynamic signalling from the wireless communications network.

11. A method according to claim 10, wherein the re-mapping control signal comprises an indication of an offset from among a plurality of pre-configured offsets, the indicated offset indicating a frequency amount by which the communications device is to shift the at least the portion of the uplink transmission.

12.-17. (canceled)

18. A method according to claim 1, comprising
determining, based on a value of at least one parameter indicated to the communications device by the wireless communications network, that the communications device is to perform the re-mapping procedure by shifting the at least the portion of the uplink transmission to a second set of resources of the wireless radio interface, the second set of resources being within a second frequency range different to the first frequency range.

19. A method according to claim 1, comprising
determining, based on a value of at least one parameter which is pre-configured and known to the communications device, that the communications device is to perform the re-mapping procedure by shifting the at least the portion of the uplink transmission to a second set of resources of the wireless radio interface, the second set of resources being within a second frequency range different to the first frequency range.

20.-22. (canceled)

23. A communications device comprising
transceiver circuitry, and
controller circuitry configured in combination with the transceiver circuitry
to determine that the communications device is to transmit an uplink transmission to a wireless communications network at least partially within a first set of resources of a wireless radio interface, the first set of resources being within a first frequency range,
to determine that a portion of the uplink transmission at least partially overlaps in time and frequency with one or more resource units configured for the transmission of downlink transmissions within the first frequency range,
to perform a re-mapping procedure on at least the portion of the uplink transmission, and
to transmit, after performing the re-mapping procedure, the uplink transmission to the wireless communications network.

24. (canceled)

25. A method of operating an infrastructure equipment forming part of a first wireless communications network, the method comprising
transmitting, to a communications device, a re-mapping control signal indicating that the communications device is to perform a re-mapping procedure on at least a portion of an uplink transmission to be received by the infrastructure equipment from the communications device at least partially within a first set of resources of a wireless radio interface provided by the infrastructure equipment, the first set of resources being within a first frequency range, wherein the portion of the uplink transmission at least partially overlaps in time and frequency with one or more resource units configured for the transmission of downlink transmissions within the first frequency range, and
receiving, in accordance with the determined re-mapping procedure, the uplink transmission from the communications device.

26. A method according to claim 25, wherein the re-mapping control signal indicates that the re-mapping procedure is not to comprise the communications device shifting the at least the portion of the uplink transmission in frequency, and the method comprises
determining that the re-mapping procedure is to comprise the communications device dropping the portion of the uplink transmission, and wherein the receiving the uplink transmission comprises receiving the uplink transmission without the dropped portion of the uplink transmission.

27. A method according to claim 25, wherein the re-mapping control signal indicates that the re-mapping procedure is not to comprise the communications device shifting the at least the portion of the uplink transmission in frequency, and the method comprises
determining that the re-mapping procedure is to comprise the communications device dropping the entire uplink transmission.

28. A method according to claim 25, wherein the uplink transmission consists of a plurality of repetitions of an uplink signal and the re-mapping control signal indicates that the re-mapping procedure is not to comprise the communications device shifting the at least the portion of the uplink transmission in frequency, and the method comprises
determining that the re-mapping procedure is to comprise the communications device dropping one or more of the repetitions of the uplink signal.

29. A method according to claim 25, wherein the re-mapping control signal indicates that the re-mapping procedure is to comprise the communications device shifting only the portion of the uplink transmission in frequency.

30. A method according to claim 25, wherein the re-mapping control signal indicates that the re-mapping procedure is to comprise the communications device shifting the entire uplink transmission in frequency.

31. A method according to claim 25, wherein the re-mapping control signal comprises an indication of an offset, the offset indicating a frequency amount by which the communications device is to shift the at least the portion of the uplink transmission.

32. A method according to claim 25, wherein the re-mapping control signal is transmitted by the infrastructure equipment to the communications device via dynamic signalling.

33. A method according to claim 32, wherein the re-mapping control signal comprises an indication of an offset from among a plurality of pre-configured offsets, the indicated offset indicating a frequency amount by which the communications device is to shift the at least the portion of the uplink transmission.

34. A method according to claim 25, wherein the re-mapping control signal is transmitted by the infrastructure equipment to the communications device via semi-static signalling.

35. A method according to claim 25, wherein the first set of resources are periodic pre-configured resources indicated in semi-static signalling transmitted by the infrastructure equipment to the communications device.

36.-87. (canceled)
